(19) United States
(12) Patent Application Publication
(10) Pub. No.: US 2013/0258062 A1
(43) Pub. Date: Oct. 3, 2013

(54) METHOD AND APPARATUS FOR GENERATING 3D STEREOSCOPIC IMAGE

(71) Applicants: Junyong NOH, Daejeon (KR); Sangwoo LEE, Seoul (KR); Young-Hui KIM, Namyangju-si (KR)

(72) Inventors: Junyong NOH, Daejeon (KR); Sangwoo LEE, Seoul (KR); Young-Hui KIM, Namyangju-si (KR)

(73) Assignee: KOREA ADVANCED INSTITUTE OF SCIENCE AND TECHNOLOGY, Daejeon (KR)

(21) Appl. No.: 13/489,092

(22) Filed: Jun. 5, 2012

(30) Foreign Application Priority Data
Mar. 29, 2012 (KR) 10-2012-0032207

(51) Int. Cl. H04N 13/02; G06T 17/00

(52) U.S. Cl. 348/47; 345/420; 348/E13.074; 348/E13.014; 348/E13.022

(57) ABSTRACT

Provided is a method for generating a 3D stereoscopic image, which includes: generating at least one 3D mesh surface by applying 2D depth map information to a 2D planar image; generating at least one 3D solid object by applying a 3D template model to the 2D planar image; arranging the 3D mesh surface and the 3D solid object on a 3D space and fixing a viewpoint; providing an interface so that cubic effects of the 3D mesh surface and the 3D solid object are correctable on the 3D space, and correcting the cubic effects of the 3D mesh surface and the 3D solid object according to a control value input through the interface; and obtaining a 3D solid image by photographing the corrected 3D mesh surface and 3D solid object with at least two cameras.

### CROSS-REFERENCE TO RELATED APPLICATIONS

This application claims priority under 35 U.S.C. §119 to Korean Patent Application No. 10-2012-0032207, filed on Mar. 29, 2012, in the Korean Intellectual Property Office, the disclosure of which is incorporated herein by reference in its entirety.

### TECHNICAL FIELD

The following disclosure relates to a 3D stereoscopic image generating technique, and in particular, to a technique allowing a 2D depth map for generating a 3D stereoscopic image and a 3D template model to be simultaneously adjusted and rendered on a 3D space.

### BACKGROUND

Different from an existing 2-dimension (hereinafter, 2D), a 3-dimensional (hereinafter, 3D) image technique is similar to an actual image seen and felt by a person and thus expected to take the lead in a next-generation digital image culture as a conceptual realistic image media which raises the quality level of visual information by several notches.

Such a 3D stereoscopic image may be obtained by directly photographing an object with several cameras, or by converting a 2D planar image into a 3D stereoscopic image having a cubic effect.

In the case where a 3D stereoscopic image is generated by using a 2D planar image, the 2D planar image is divided into a background and each object, and then depth information is endowed to the background and each object, so that the 2D planar image may be converted into a 3D stereoscopic image having a cubic effect. However, since the depth information of each object divided from the 2D planar image shows a simple planar shape, a method for correcting the depth information more accurately is required to express an actual object.

Generally, in order to solve this problem, a method for applying basic figures, to which a depth map is applied, to an object present in an image and having a similar shape (hereinafter, a depth information correcting method using a template shape) as shown in FIG. 1 and a method for applying the same depth map to an image so that a user directly infers a depth map from the map and corrects the depth information (hereinafter, a depth information correcting method using a user definition) as shown in FIG. 2 are used. For example, in regard to an object having a complicated and irregular shape, the depth information correcting method using a user definition is applied so that the user may arbitrarily correct the depth map, and in regard to an object having a simple and regular shape, the depth information correcting method using a template shape is applied to correct the depth information of the corresponding object.

However, the depth information correcting method using a template shape may be used on a 3D space, and the depth information correcting method using a user definition may be performed only on a 2D space. In other words, since two methods above are performed on different working spaces, if the depth information is corrected by utilizing both methods, the work efficiency is deteriorated.

### SUMMARY

An embodiment of the present disclosure is directed to providing method and apparatus for generating a 3D stereoscopic image, which may improve the work efficiency by allowing both a depth information correcting method using a template shape and a depth information correcting method using a user definition to be performed on a 3D space.

In a general aspect, there is provided a method for generating a 3D stereoscopic image, which includes: generating at least one 3D mesh surface by applying 2D depth map information to a 2D planar image; generating at least one 3D solid object by applying a 3D template model to the 2D planar image; arranging the 3D mesh surface and the 3D solid object on a 3D space and fixing a viewpoint; providing an interface so that cubic effects of the 3D mesh surface and the 3D solid object are correctable on the 3D space, and correcting the cubic effects of the 3D mesh surface and the 3D solid object according to a control value input through the interface; and obtaining a 3D solid image by photographing the corrected 3D mesh surface and 3D solid object with at least two cameras.

In the correcting of cubic effects of the 3D mesh surface and the 3D solid object, after the 3D mesh surface and the 3D solid object become correctable, a pixel or feature of the 3D mesh surface and the 3D solid object may be selected according to the control value input through the interface, and a height of the selected pixel or feature may be corrected.

The method may further include recalculating a 2D depth map and a 3D template model from the corrected 3D mesh surface and 3D solid object, and storing the recalculated 2D depth map and 3D template model in an internal memory.

In the generating of at least one 3D mesh surface, 2D depth map information may be applied to a 2D planar image in the unit of layer to generate a 3D mesh surface of each layer.

In the generating of at least one 3D solid object, an object having a similar shape to the 3D template model may be checked among objects included in the 2D planar image, and the 3D template model may be applied to the checked object to generate a 3D solid object.

In another aspect, there is also provided an apparatus for generating a 3D stereoscopic image, which includes: a 3D model generating unit for generating at least one of a 3D mesh surface and a 3D solid object by applying 2D depth map information and a 3D template model to a 2D planar image; a 3D space arranging unit for arranging the 3D mesh surface and the 3D solid object on a 3D space and fixing a viewpoint; a depth adjusting unit for providing an interface so that cubic effects of the 3D mesh surface and the 3D solid object are adjustable on the 3D space, and correcting the cubic effects of the 3D mesh surface and the 3D solid object according to a control value input through the interface; and a rendering unit for generating a 3D solid image by rendering the corrected 3D mesh surface and 3D solid object with at least two cameras.

The 3D model generating unit may include: a 3D mesh service generating unit for generating a 3D mesh surface of each layer by applying the 2D depth map information to the 2D planar image in the unit of layer; and a 3D template model matching unit for checking an object having a similar shape to the 3D template model among objects included in the 2D planar image, and applying the 3D template model to the checked object to generate a 3D solid object.

The interface allows a user to check the 3D mesh surface and the 3D solid object arranged on the 3D space by the naked eye and allows the cubic effects of the 3D mesh surface and the 3D template model to be corrected on the 3D space in the unit of pixel or feature.

The depth adjusting unit may further have a function of, in the case where the 3D mesh surface and the 3D template model are completely corrected, automatically calculating a new 2D depth map from the corrected 3D mesh surface and automatically calculating new 3D object depth information from the corrected template model, and then storing the calculated new 2D depth map and 3D object depth information in the memory.

In the present disclosure, since a 2D depth map is converted into a 3D model and its depth may be adjusted and rendered together with a 3D template model, a worker may correct a 2D depth map and a 3D template model on a single space simultaneously. In addition, results of the 2D depth map correction work and the 3D template model correction work may be checked on the 3D space in real time. As a result, the movement and time of the worker may be greatly reduced, which remarkably enhances the work efficiency.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 is a diagram for illustrating a general depth information correcting method using a template shape;

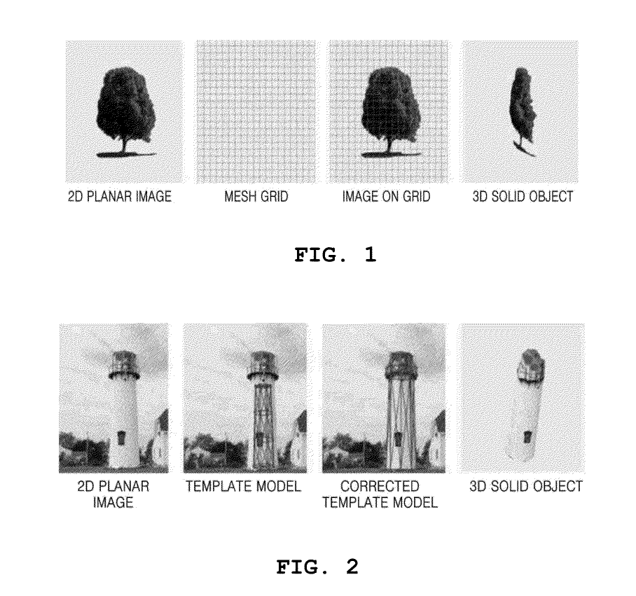

FIG. 2 is a diagram for illustrating a general depth information correcting method using a user definition;

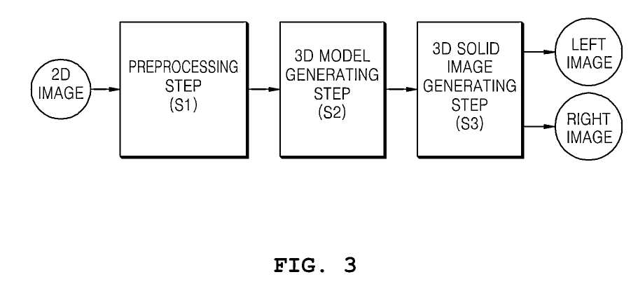

FIG. 3 is a schematic diagram for illustrating a general method for generating a 3D stereoscopic image by using a 2D planar image;

FIG. 4 is a diagram showing an apparatus for generating a 3D stereoscopic image according to an embodiment of the present disclosure;

FIGS. 5a to 5d are diagrams for illustrating an example of depth adjustment on a 3D space according to an embodiment of the present disclosure;

FIG. 6 is a diagram for illustrating a method for generating a 3D stereoscopic image according to an embodiment of the present disclosure;

FIG. 7 is a diagram showing layers of a 2D planar image according to an embodiment of the present disclosure;

FIG. 8 is a diagram showing a depth map of each layer according to an embodiment of the present disclosure;

FIG. 9 is a diagram showing a 3D mesh surface of each layer according to an embodiment of the present disclosure;

FIG. 10 is a diagram showing a viewpoint-fixed 3D mesh surface of each layer according to an embodiment of the present disclosure;

FIG. 11 is a diagram showing an example of camera arrangement for rendering according to an embodiment of the present disclosure; and

FIG. 12 is a diagram showing an example of a 3D solid image generated by the method for generating a 3D stereoscopic image according to an embodiment of the present disclosure.

### DETAILED DESCRIPTION OF EMBODIMENTS

Hereinafter, preferred embodiments of the present disclosure will be described with reference to the accompanying drawings to illustrate the present disclosure in detail so that a person skilled in the art may easily implement the present disclosure. However, the present disclosure may be implemented in various different ways, without being limited to the following embodiments.

In the drawings, in order to clearly describe the present disclosure, explanations extrinsic to the essential features of the present disclosure will be omitted, and the same reference symbol in the drawings represents the same component.

In addition, in the entire specification, when expressing that any part “includes” a component, it means that the part can further include another component, without excluding other components, if not otherwise indicated.

For better understanding of the present disclosure, a method for generating a 3D stereoscopic image by using a 2D planar image will be briefly described.

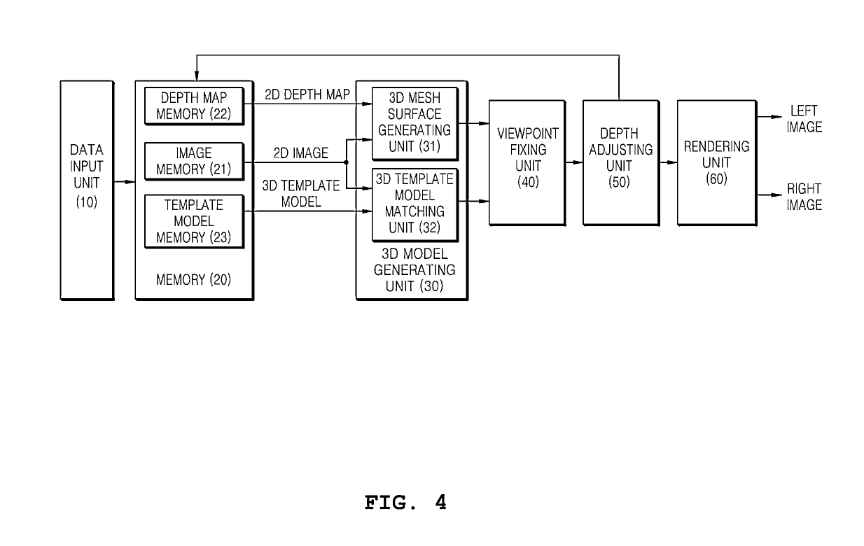

The method for generating a 3D stereoscopic image by using a 2D planar image may include, as shown in FIG. 3, a preprocessing step (S1), a 3D model generating step (S2), and a 3D solid image generating step (S3). First, in the preprocessing step, the 2D planar image is divided into a background and each object. In addition, holes created in the divided image are filled, the divided background and each object are stored in the unit of layer, and then a 2D depth map and a 3D template model (or, 3D object depth information) of the background and each object are extracted by using each layer data. In addition, in the 3D model generating step, the extracted 2D depth map and 3D template model are reflected on the 2D planar image to generate a 3D model. Finally, right and left images are generated by using the 3D model.

The present disclosure is directed to method and apparatus for performing the 3D model generating process and the 3D solid image generating process, among the above processes, and particularly to method and apparatus for providing a means capable of adjusting and rendering a 2D depth map and a 3D template model required for the generation of a 3D model on a 3D space.

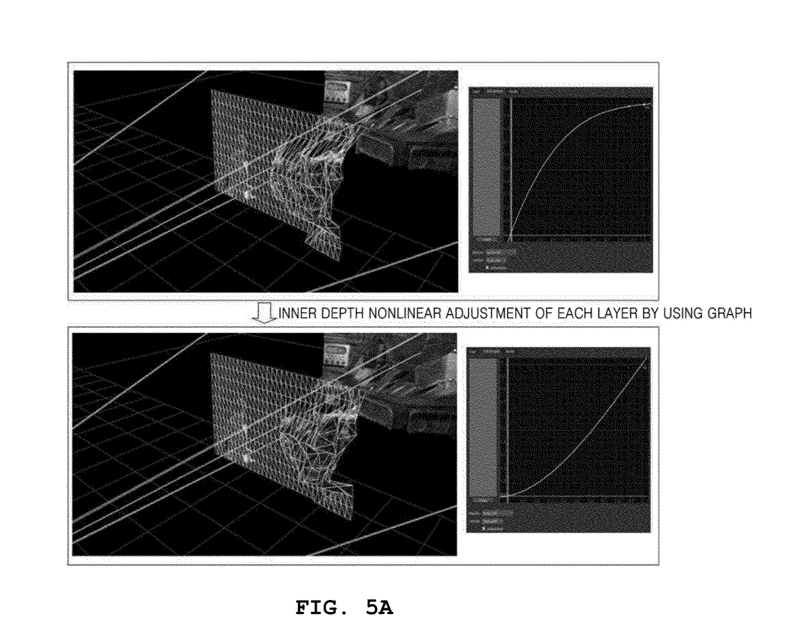

FIG. 4 shows an apparatus for generating a 3D stereoscopic image according to an embodiment of the present disclosure.

Referring to FIG. 4, the apparatus for generating a 3D stereoscopic image according to the present disclosure includes a data input unit 10, a memory 20, a 3D model generating unit 30, a 3D space arranging unit 40, a depth adjusting unit 50, and a rendering unit 60. A 2D depth map is converted into a 3D model and then arranged on a 3D space together with a 3D template model, so that the 2D depth map and the 3D template model may be simultaneously adjusted and rendered on the same space.

The data input unit 10 receives input data transmitted in the preprocessing step, and extracts a 2D planar image included in the input data, 2D depth map information for at least one of a background and objects of the 2D planar image and a 3D template model having depth information of at least one of objects of the 2D planar image.

The memory 20 includes an image memory 21, a depth map memory 22, and a template model memory 23, and classifies and stores 2D planar image, 2D depth map information, and 3D template model extracted by the data input unit 10.

The 3D model generating unit 30 includes a 3D mesh surface generating unit 31, a 3D template model matching unit 32, and a 3D space arranging unit 40, and arranges both a 3D model generated by using the 2D depth map and 3D models generated by using the 3D template model on the 3D space, so that a user may simultaneously correct both the 2D depth map and the 3D template model on the 3D space.

The 3D mesh surface generating unit 31 applies 2D depth map information corresponding to at least one of the background and objects to the 2D planar image, thereby generating at least one 3D mesh surface which is a curved surface having a 3D cubic effect, namely at least one 3D model.

The 3D template model matching unit 32 extracts objects included in the 2D planar image, compares the extracted objects with the 3D template model stored in the template model memory 23, and checks an object having a similar shape to the 3D template model. In addition, the 3D template model is corrected and applied according to the shape of the corresponding object to generate a 3D solid object, namely a 3D model.

The 3D space arranging unit 40 includes a virtual rendering camera, and arranges the 3D mesh surface generated by the 3D mesh surface generating unit 31 and the 3D solid object generated by the 3D template model matching unit 32 on the 3D space together. In addition, the 3D mesh surface and the 3D template model are automatically arranged according to a rendering camera view by using a parameter of a rendering camera, and a viewpoint is fixed. In this case, the 3D mesh surface and the 3D template model have a fixed camera viewpoint, which is an always fixed viewpoint regardless of a working viewpoint of a user.

the interface allows a user to check the 3D mesh surface and the 3D solid object arranged on the 3D space by the naked eye and allows the cubic effects of the 3D mesh surface and the 3D template model to be corrected on the 3D space in the unit of pixel or feature.

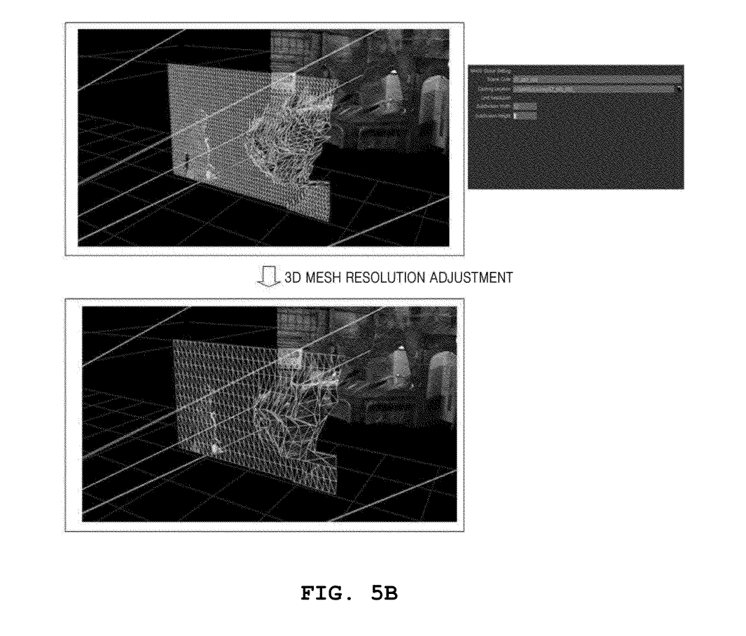

The depth adjusting unit 50 allows a user to check the 3D mesh surface and the 3D solid object arranged on the 3D space by the naked eye, and provides a depth correcting interface which allows cubic effects of the 3D mesh surface and the 3D template model to be corrected on the 3D space in various ways. The depth correcting interface of the present disclosure may support an inner depth nonlinear adjusting operation of each layer by using a graph (see FIG. 5a), a 3D mesh resolution adjusting operation (see FIG. 5b), a depth sense adjusting operation of each layer (see FIG. 5c), a depth sense adjusting operation by using intraocular distance (IOD) value adjustment (see FIG. 5d) or the like. In addition, by displaying cubic effects of the mesh surface and the template model according to the operations in real time, a user may perform the depth sense adjusting operation in a faster and easier way.

Further, if the mesh surface and the template model are completely corrected, the depth adjusting unit 50 automatically calculates a new 2D depth map from the 3D mesh surface and new 3D object depth information from the template model, and then stores the new 2D depth map and the new 3D object depth information respectively in the depth map memory 22 and the template model memory 23, so that the corresponding information may be reused afterwards.

The rendering unit 60 includes two stereo cameras disposed at both right and left sides of the rendering camera. In addition, locations and directions of two stereo cameras are adjusted to control viewpoints and cross point of both eyes, and the 3D mesh surface and the 3D solid object (namely, 3D models) are rendered to obtain right and left images desired by the user.

FIGS. 5a to 5d are diagrams for illustrating a depth adjustment method on a 3D space according to an embodiment of the present disclosure.

FIG. 5a is a screen for supporting the inner depth nonlinear adjusting operation of each layer by using a graph. Referring to FIG. 5a, it could be understood that the cubic effects of the 3D mesh surface and the 3D solid object arranged on the 3D space may be adjusted in the unit of 3D feature. In addition, if a user selects a specific feature and adjusts a depth value thereof, the adjustment result is displayed in real time so that the user may easily estimate the cubic effects of the 3D mesh surface and the 3D solid object without separate rendering operation.

FIG. 5b is a screen for supporting the 3D mesh resolution adjusting operation. In the present disclosure, depth adjustment resolutions of the 3D mesh surface and the 3D solid object may also be adjusted as desired, and the adjustment result is displayed on the 3D space so that the user may instinctively check the result.

FIG. 5c is a screen for supporting the depth sense adjusting operation of each layer. As shown in FIG. 5c, each layer may be individually selected, and a distance to the rendering camera may be adjusted.

In addition, as shown in FIG. 5d, a window where a user may manually input an IOD value is provided, so that the depth sense adjusting operation by using IOD value adjustment may also be performed.

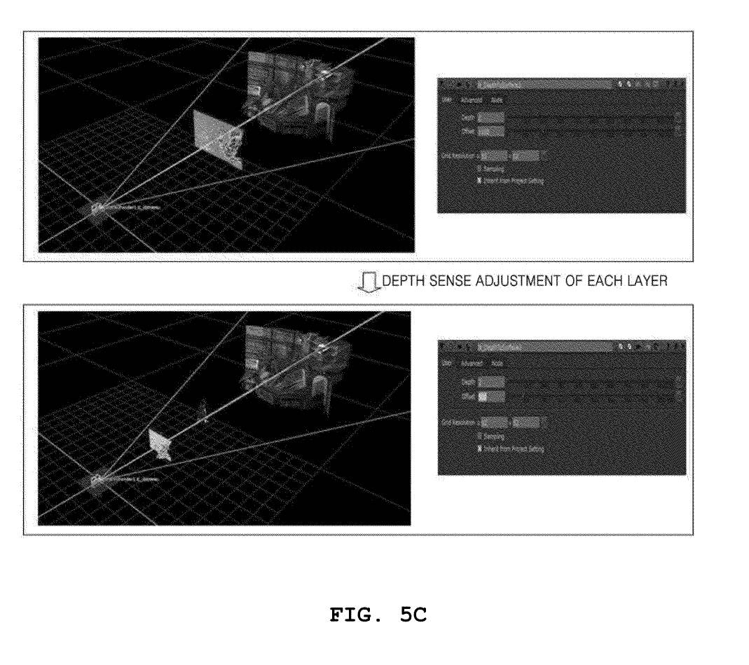

Hereinafter, a method for generating a 3D stereoscopic image according to an embodiment of the present disclosure will be described with reference to FIG. 6.

First, the apparatus for generating a 3D stereoscopic image receives input data and extracts a 2D planar image included in the input data, 2D depth map information of at least one of a background and objects of the 2D planar image, and information of a 3D template model of at least one of the objects of the 2D planar image (S10, S11, S12).

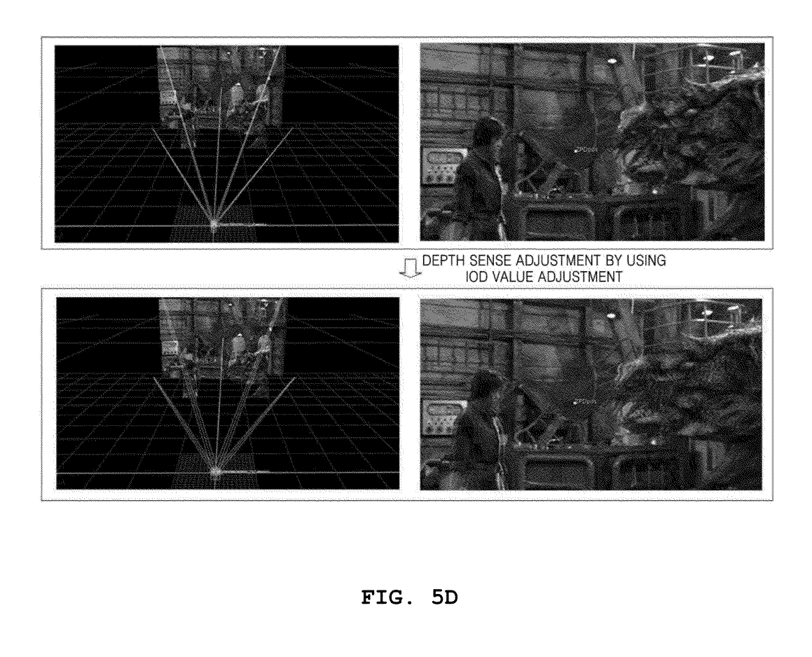

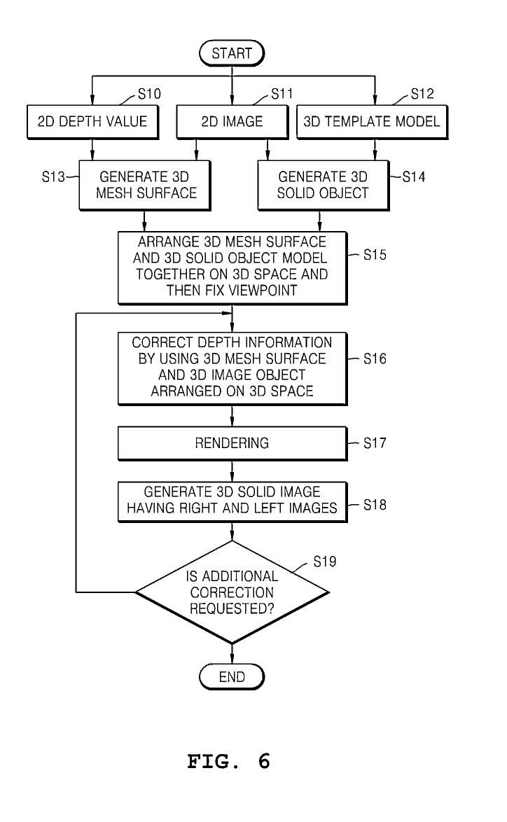

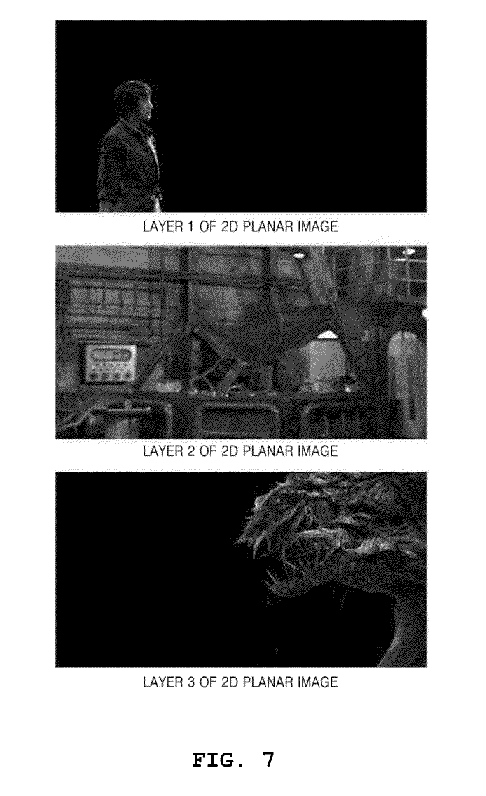

In addition, the 2D depth map information is applied to the 2D planar image in the unit of layer to generate a 3D mesh surface of each layer (S13). In other words, in order to provide the 2D planar image configured with layers as shown in FIG. 7 and the 2D depth map information corresponding to each layer as shown in FIG. 8 together, the apparatus for generating a 3D stereoscopic image applies the 2D depth map information to the 2D planar image in the unit of layer to generate a 3D mesh surface of each layer as shown in FIG. 9. Each 3D mesh surface generated as above will have a cubic effect corresponding to the 2D depth map information.

In addition, the apparatus for generating a 3D stereoscopic image may perform a 3D solid image generating operation by using the 2D depth map information and a 3D solid image generating operation by using the 3D template model, simultaneously. In other words, together with performing S13, the present disclosure checks an object having a similar shape to the 3D template model among objects included in the 2D planar image, and applies the 3D template model to the corresponding object to generate a 3D solid object (S14).

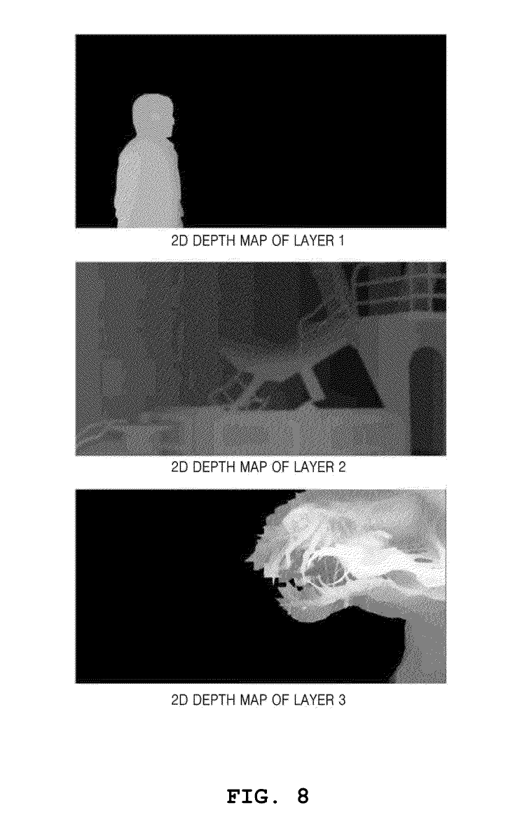

After that, the 3D mesh surface of each layer generated in S13 and the 3D solid object generated in S14 are arranged together on the 3D space as shown in FIG. 10, and arranged and fixed according to a rendering camera viewpoint. Then, the depth map correcting interface is activated so that the 3D mesh surface and the 3D solid object become correctable (S15).

In addition, the cubic effect of at least one of the 3D mesh surface and the 3D solid object is corrected in various ways (namely, inner depth nonlinear adjustment of each layer by using a graph, 3D mesh resolution adjustment, depth sense adjusting operation of each layer, IOD value adjustment or the like) on the 3D space by means of the depth map correcting interface, and the correction result is checked in real time (S16). At this time, the depth information corresponding to the corrected 3D mesh surface and 3D solid object is backed up in the depth map memory 22 and the template model memory 23 in real time.

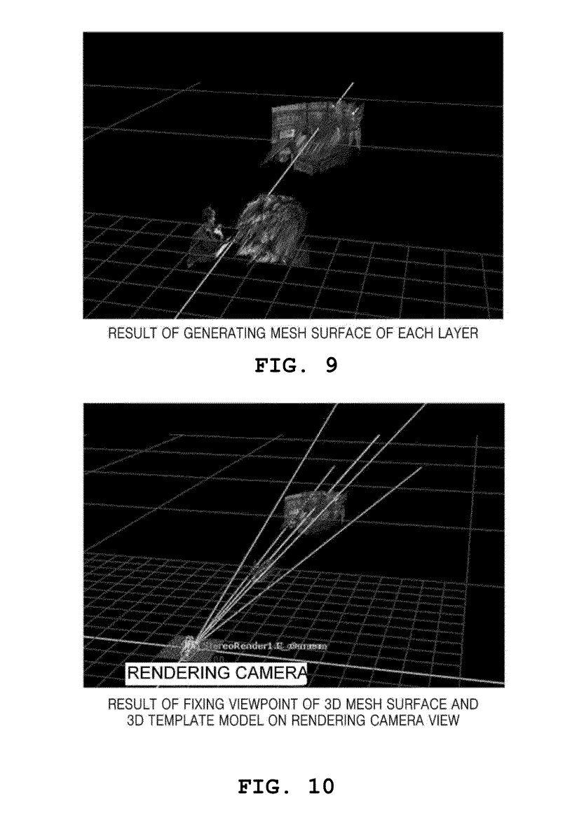

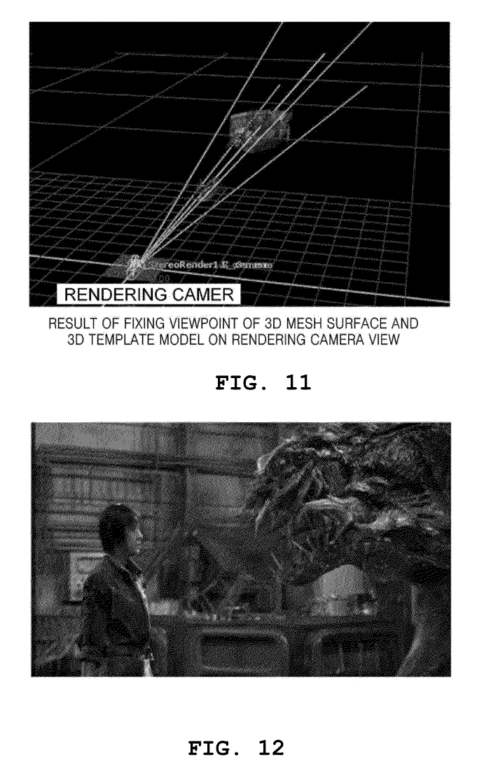

If a user requests a rendering operation after completely correcting the cubic effects of the 3D mesh surface and the 3D solid object, the apparatus for generating a 3D stereoscopic image photographs the corrected 3D mesh surface and 3D template model with two cameras disposed at the right and left of the rendering camera as shown in FIG. 11, namely performs the rendering operation (S17), and generates and outputs a 3D solid image having right and left images as shown in FIG. 12 (S18).

In addition, after checking whether the user wishes additional correction, the process proceeds to S16 to additionally correct the cubic effects of the 3D mesh surface and the 3D solid object or end the operation (S19).

As described above, the present disclosure allows both the depth map information on the 2D space and the object depth information on the 3D space to be rendered on a single 3D space, thereby proposes a more instinctive and more convenient solid image generating pipeline to a user.

While the present disclosure has been described with respect to the specific embodiments, it will be apparent to those skilled in the art that various changes and modifications may be made without departing from the spirit and scope of the disclosure as defined in the following claims.

What is claimed is:

1. A method for generating a 3D stereoscopic image, comprising:
generating at least one 3D mesh surface by applying 2D depth map information to a 2D planar image;
generating at least one 3D solid object by applying a 3D template model to the 2D planar image;
arranging the 3D mesh surface and the 3D solid object on a 3D space and fixing a viewpoint;
providing an interface so that cubic effects of the 3D mesh surface and the 3D solid object are correctable on the 3D space, and correcting the cubic effects of the 3D mesh surface and the 3D solid object according to a control value input through the interface; and
obtaining a 3D solid image by photographing the corrected 3D mesh surface and 3D solid object with at least two cameras.

2. The method for generating a 3D stereoscopic image according to claim 1, wherein, in said correcting of cubic effects of the 3D mesh surface and the 3D solid object, after the 3D mesh surface and the 3D solid object become correctable, a pixel or feature of the 3D mesh surface and the 3D solid object are selected according to the control value input through the interface, and a height of the selected pixel or feature is corrected.

3. The method for generating a 3D stereoscopic image according to claim 1, further comprising:
recalculating a 2D depth map and a 3D template model from the corrected 3D mesh surface and 3D solid object, and storing the recalculated 2D depth map and 3D template model in an internal memory.

4. The method for generating a 3D stereoscopic image according to claim 1, wherein, in said generating of at least one 3D mesh surface, 2D depth map information is applied to a 2D planar image in the unit of layer to generate a 3D mesh surface of each layer.

5. The method for generating a 3D stereoscopic image according to claim 1, wherein, in said generating of at least one 3D solid object, an object having a similar shape to the 3D template model is checked among objects included in the 2D planar image, and the 3D template model is applied to the checked object to generate a 3D solid object.

6. A method for generating a 3D stereoscopic image, comprising:
a 3D model generating unit for generating at least one of a 3D mesh surface and a 3D solid object by applying 2D depth map information and a 3D template model to a 2D planar image;
a 3D space arranging unit for arranging the 3D mesh surface and the 3D solid object on a 3D space and fixing a viewpoint;
a depth adjusting unit for providing an interface so that cubic effects of the 3D mesh surface and the 3D solid object are adjustable on the 3D space, and correcting the cubic effects of the 3D mesh surface and the 3D solid object according to a control value input through the interface; and
a rendering unit for generating a 3D solid image by rendering the corrected 3D mesh surface and 3D solid object with at least two cameras.

7. The method for generating a 3D stereoscopic image according to claim 6, wherein the 3D model generating unit generates a 3D mesh surface of each layer by applying the 2D depth map information to the 2D planar image in the unit of layer.

8. The method for generating a 3D stereoscopic image according to claim 6, wherein, in said generating of at least one 3D solid object, an object having a similar shape to the 3D template model is checked among objects included in the 2D planar image, and the 3D template model is applied to the checked object to generate a 3D solid object.

9. An apparatus for generating a 3D stereoscopic image, comprising:
a 3D model generating unit for generating at least one of a 3D mesh surface and a 3D solid object by applying 2D depth map information and a 3D template model to a 2D planar image;
a 3D space arranging unit for arranging the 3D mesh surface and the 3D solid object on a 3D space and fixing a viewpoint;
a depth adjusting unit for providing an interface so that cubic effects of the 3D mesh surface and the 3D solid object are adjustable on the 3D space, and correcting the cubic effects of the 3D mesh surface and the 3D solid object according to a control value input through the interface; and
a rendering unit for generating a 3D solid image by rendering the corrected 3D mesh surface and 3D solid object with at least two cameras.

10. The apparatus for generating a 3D stereoscopic image according to claim 9, wherein the 3D model generating unit includes:
a 3D mesh service generating unit for generating a 3D mesh surface of each layer by applying the 2D depth map information to the 2D planar image in the unit of layer; and
a 3D template model matching unit for checking an object having a similar shape to the 3D template model among objects included in the 2D planar image, and applying the 3D template model to the checked object to generate a 3D solid object.

11. The apparatus for generating a 3D stereoscopic image according to claim 9, wherein the interface allows a user to check the 3D mesh surface and the 3D solid object arranged on the 3D space by the naked eye and allows the cubic effects of the 3D mesh surface and the 3D template model to be corrected on the 3D space in the unit of pixel or feature.

12. The apparatus for generating a 3D stereoscopic image according to claim 9, further comprising a memory for classifying and storing the 2D planar image, the 2D depth map information and the 3D template model.

13. The apparatus for generating a 3D stereoscopic image according to claim 9, wherein the depth adjusting unit further includes a function of, in the case where the 3D mesh surface and the 3D template model are completely corrected, automatically calculating a new 2D depth map from the corrected 3D mesh surface and automatically calculating new 3D object depth information from the corrected template model, and then storing the calculated new 2D depth map and 3D object depth information in the memory.
